(19) United States
(12) Patent Application Publication
(10) Pub. No.: US 2018/0318938 A1
(43) Pub. Date: Nov. 8, 2018

(54) Axle Arrangement for Mounting a Tool or a Workpiece and Method for Operating the Axle Arrangement

(71) Applicant: Walter Maschinenbau GmbH, Tübingen (DE)

(72) Inventors: Andreas Fasold-Schmid, Pfullingen (DE); Daniel Schindler, Weil im Schönbuch (DE)

(21) Appl. No.: 15/779,918

(22) PCT Filed: Nov. 16, 2016
(86) PCT No.: PCT/EP2016/077895

§ 371 Date: May 30, 2018

(30) Foreign Application Priority Data
Dec. 7, 2015 (DE) 10 2015 121 228.5

(51) Int. Cl. B23B 31/26; B23B 31/20

(52) U.S. Cl. CPC B23B 31/261; B23B 31/205; B23B 2270/027; B23B 2260/008; B23B 2260/0087; B23B 2231/50

(57) ABSTRACT

The invention relates to an axle arrangement (10) for mounting a tool or a workpiece. The axle arrangement (10) comprises a receiving unit (12) that is supported by a swivel bearing assembly (13) in a base body (11) so as to be rotatable about a longitudinal axis L. The receiving unit (12) has a receiving sleeve (18) that is supported so as to be immovable in longitudinal direction R parallel to the longitudinal axis L and has a gripper actuating element (23) that is supported so as to be slidable in the receiving sleeve (18) along the longitudinal axis L. On one end of the gripper actuating element (23) associated with the front end (18a) of the receiving sleeve (18), there is seated a gripper unit (24) for gripping the tool or the workpiece. The gripper unit (24) is pretensioned by a pretension unit (30) in a clamping position I. An actuatable release unit (34) can move the gripper unit—counter the pretension force FV of the pretension unit (30)—into a release position II. By means of a support unit (48), an auxiliary bearing (49) that, in particular, is configured as an axial bearing, can be pressed against the receiving sleeve (18) in order to achieve an improved axial force support of the receiving unit (12) on the base body (11) and to reduce the load on the swivel bearing assembly (13) due to axial forces.

The invention relates to an axle arrangement for mounting a tool or a workpiece, as well as to a method for operating the axle arrangement.

Such an axle arrangement has been known, for example, from publication DE 103 17 097 A1. The axle arrangement comprises a base body and at least one receiving unit that is supported by means of a swivel bearing assembly so as to be rotatable about a longitudinal axis. A receiving opening is provided on the receiving sleeve. A gripper actuating element is supported in the receiving sleeve so as to be slidable along the longitudinal axis and has a gripper unit on one end, said gripper unit interacting with the receiving opening. By means of a release unit, the gripper actuating element can be moved along the longitudinal axis—counter a pretension force of a pretension unit. In so doing, the gripper unit is moved into a release position. If the release unit is not active, the pretension force presses the gripper unit into a clamping position.

The force to be applied by the release unit must be supported on the base body of the axle arrangement. However, the swivel bearing assembly is disposed to mainly support radial forces for the rotatable support of the receiving unit. If the gripper unit is in the release position, axial forces are also supported via the bearing unit. This frequently has the effect that—due to the specifications of the swivel bearing assembly—no rotating movement of the receiving unit can be allowed on account of the great axial forces so as not to damage the swivel bearing assembly.

Considering this prior art, it is the object of the invention to improve an axle arrangement of the above-described type.

The invention achieves this object with an axle arrangement exhibiting the features of Patent Claim 1, as well as with a method exhibiting the features of Patent Claim 15.

In accordance with the invention, the axle arrangement comprises a base body. A receiving unit is supported via a swivel bearing assembly on or in the base body so as to be rotatable about a longitudinal axis. The receiving unit comprises a receiving sleeve with a receiving opening. The receiving opening is located on the end of the axle arrangement where the tool or the workpiece is to be mounted.

A gripper actuating element of the receiving unit is supported in the receiving sleeve so as to be slidable along the longitudinal axis. The gripper actuating element may have the form of a rod or a bar and be configured as a push rod. At the end associated with the receiving opening, a gripper unit is arranged on the gripper actuating element. The gripper unit is disposed to grip or hold the tool or the workpiece.

The gripper actuating element is supported so that it can be slid relative to the receiving sleeve. The receiving sleeve is arranged so as to immovable in the direction of the longitudinal axis and preferably so as to be movable only within one degree of rotational freedom.

A pretension unit that is a component of the receiving unit is disposed to generate a pretension force in longitudinal direction parallel to the longitudinal axis between the gripper unit and the receiving sleeve. The pretension force forces the gripper unit into a clamping position in which the tool or the workpiece is mounted in the receiving unit and thus the axle arrangement. The pretension force is oriented, in particular, in such a manner that the gripper unit is pulled into the receiving opening. Via an activatable release unit, it is possible to move the gripper unit and, preferably, the gripper actuating element together with the gripper unit, counter the pretension force along the longitudinal axis. As a result of this, the gripper unit can be moved out of the clamping position into a release position. In the release position, it is possible to remove a tool or a workpiece from the gripper unit or to insert another tool or workpiece into the gripper unit. The activatable release unit is able to pneumatically and/or hydraulically and/or electrically generate the force required for moving the gripper unit.

Furthermore, the axle arrangement comprises a support unit. The support unit is arranged on the base body. The support unit can be switched between a support state and a rest state. To do so, the support unit has an activatable actuating unit. Furthermore, the support unit comprises an auxiliary bearing. The actuating unit is disposed to generate a pressing force on the auxiliary bearing when the support unit is in support state and to press the auxiliary bearing against the receiving sleeve. In this support state, the support unit ensures that the receiving sleeve is supported via the auxiliary bearing on the base body, i.e., in addition to via the swivel bearing assembly. As a result of this, an additional force path is formed. If the release unit moves the gripper unit into the release position, the force generated by the release unit must be supported between the base body and the receiving sleeve of the receiving unit. Inasmuch as at least one bearing of the swivel bearing assembly cannot absorb any or only minimal axial forces and is mainly disposed to absorb radial forces for rotatable support, the auxiliary bearing effects the support of the receiving sleeve at another location. The axial force that must be supported via the swivel bearing assembly is reduced as a result of this. The swivel bearing assembly is still subjected to only a minimal load in the release position of the gripper unit when the support unit assumes its support position. Consequently, it is also possible to drive the receiving unit in the release position in a rotating manner about the longitudinal axis. The swivel bearing arrangement is not damaged due to the additional support via the auxiliary bearing and is not subjected to excessive wear.

In rest state of the support unit, the actuating unit does not apply any force to the auxiliary bearing. In rest state, the auxiliary bearing rests loosely against the receiving sleeve, or it may also be positioned at a distance from the receiving sleeve.

The auxiliary bearing is preferably configured strictly as a radial bearing. The auxiliary bearing is preferably a rolling bearing and, in the exemplary embodiment, a needle roller bearing.

The swivel bearing assembly comprises several bearings at different axial bearing locations that are able to absorb radial forces. At least two of these bearings are arranged in longitudinal direction parallel to the longitudinal axis at a distance from each other. The swivel bearing assembly may comprise at least one radial bearing. The swivel bearing assembly may comprises, furthermore, at least one combined radial/axial bearing. Preferably, the swivel bearing assembly comprises at least one angular ball bearing that is able to absorb or support radial forces and also axial forces. In a preferred exemplary embodiment, all the bearings of the swivel bearing assembly are rolling bearings. In particular, the swivel bearing assembly does not comprise an axial bearing that is disposed only for support axial forces.

It is advantageous if a first support surface is provided on the receiving sleeve, said support surface extending radially with respect to the longitudinal axis. A radial/axial bearing of the swivel bearing assembly abuts against the support surface. As a result of this, not only the occurring radial forces but also axial forces are supported between the receiving sleeve and the base body.

Furthermore, it is advantageous if the receiving sleeve has a second support surface oriented radially with respect to the longitudinal axis. The actuating unit may be disposed to press the auxiliary bearing in the support state at a specified and/or adjustable contact force against the second support surface in order to achieve an additional support of an axial force between the receiving unit and the base body.

Furthermore, the actuating unit preferably comprises an actuating cylinder. The actuating cylinder may be a pneumatic cylinder or a hydraulic cylinder. In a first exemplary embodiment, the actuating unit may also electrically generate the pressing force. A combination of an electrical and/or pneumatic and/or hydraulic generation of the pretension force is possible.

It is advantageous if a piston of the actuating cylinder is configured as an annular piston. Preferably, the annular piston is arranged coaxially with respect to the longitudinal axis. The annular piston encloses the receiving sleeve. In so doing, the auxiliary bearing may be arranged between the annular piston and the second support surface.

In one exemplary embodiment, the axle arrangement may additionally comprise a control unit. The control unit is disposed to activate the actuating unit and the release unit. Furthermore, it is possible that a drive unit for rotatably driving the receiving unit about the longitudinal axis is provided. The control unit may also activate the drive unit.

It is advantageous if the control unit is disposed to switch the support unit into the support state directly before, during or after the gripper unit is being moved or has been moved into the release position. As soon as the support state of the support unit has been taken, a rotatable driving of the receiving unit may also take place in the release position. To do so, the control unit may be disposed to stop the drive unit if the release unit for moving the gripper unit into release position is being moved or was moved—as long as the support unit has not yet assumed the support state.

Preferably, the axle unit described hereinabove is operated as follows:

When a new workpiece or tool is being inserted, the support unit is first switched into the support state. Before, during or afterwards, the gripper unit is being moved into the release position by means of the release unit. In the release position of the gripper unit, it is possible to insert a tool or workpiece. If there is still a tool or workpiece present in the gripper unit, it can be removed. When inserting or removing a tool or workpiece, the receiving unit can be rotatably driven if, as a result of this, the insertion or removal of a tool or workpiece is simplified. Subsequently, the gripper unit is moved into the clamping position. To do so, the release force is decreased by the release unit so that the pretension force forces the gripper unit into the clamping position. Preferably, after the clamping position has been assumed, the support unit is switched into rest state. In rest state, there is no support of an axial force between the receiving sleeve and the base body due to the auxiliary bearing. The rotatable driving of the receiving unit about the longitudinal axis may be performed in an energy-efficient manner without losses in the auxiliary bearing.

Advantageous embodiments of the invention can be inferred from the dependent patent claims, the description and the drawings. Hereinafter, preferred exemplary embodiments of the invention are explained in detail with reference to the appended drawings. They show in

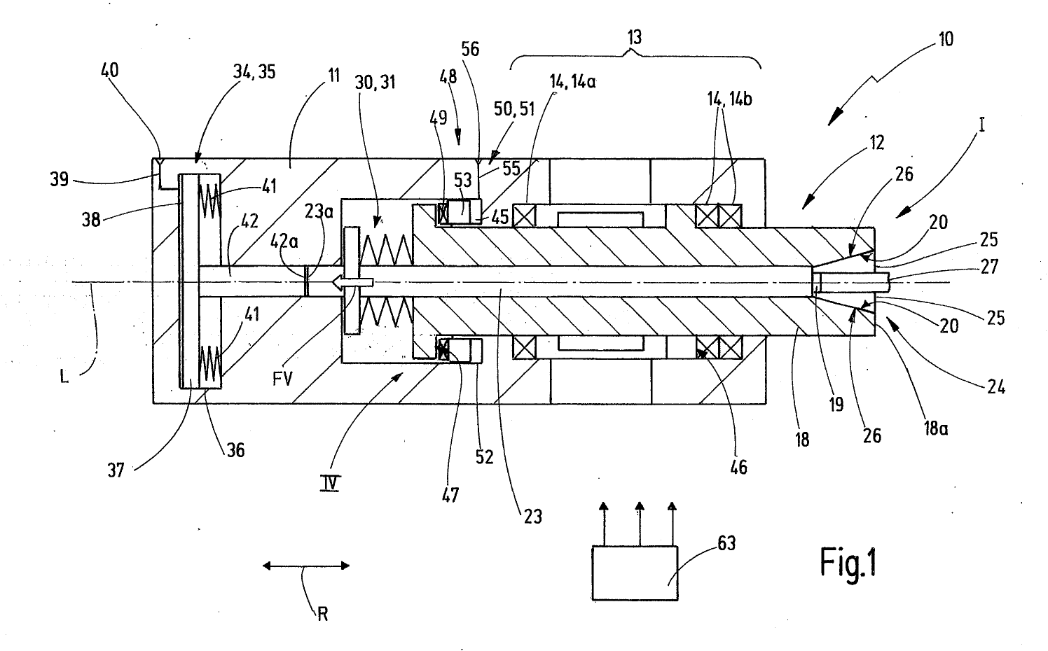

FIG. 1 a representation resembling a block diagram of an exemplary embodiment of an axle arrangement with a tool or workpiece mounted;

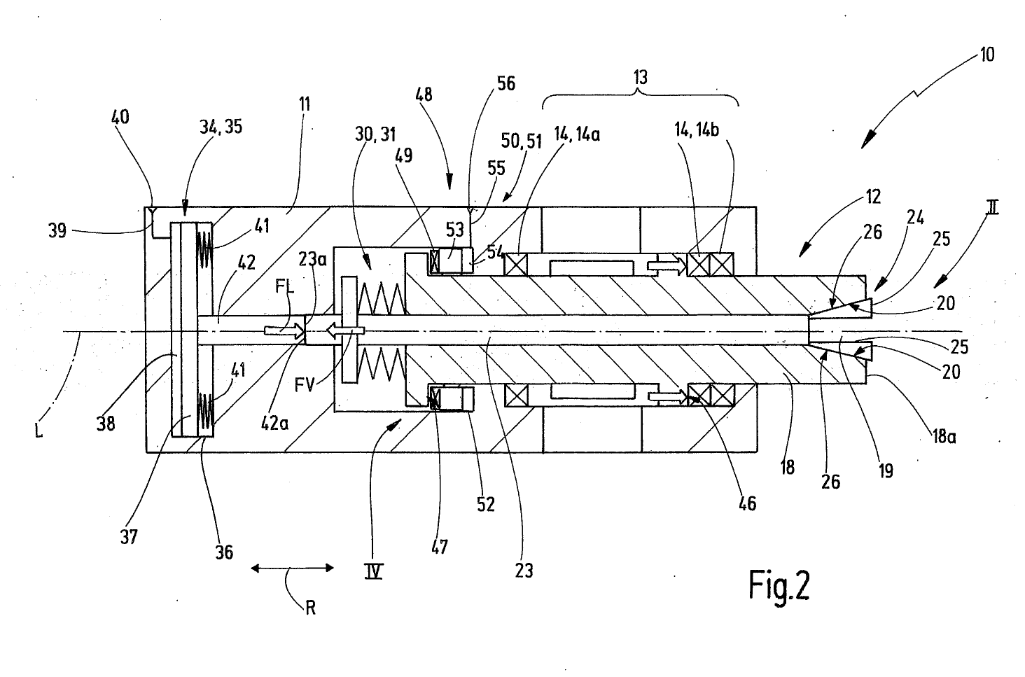

FIG. 2 the axle arrangement according to FIG. 1 with a gripper arrangement located in release position for the insertion or removal of a tool or a workpiece; and

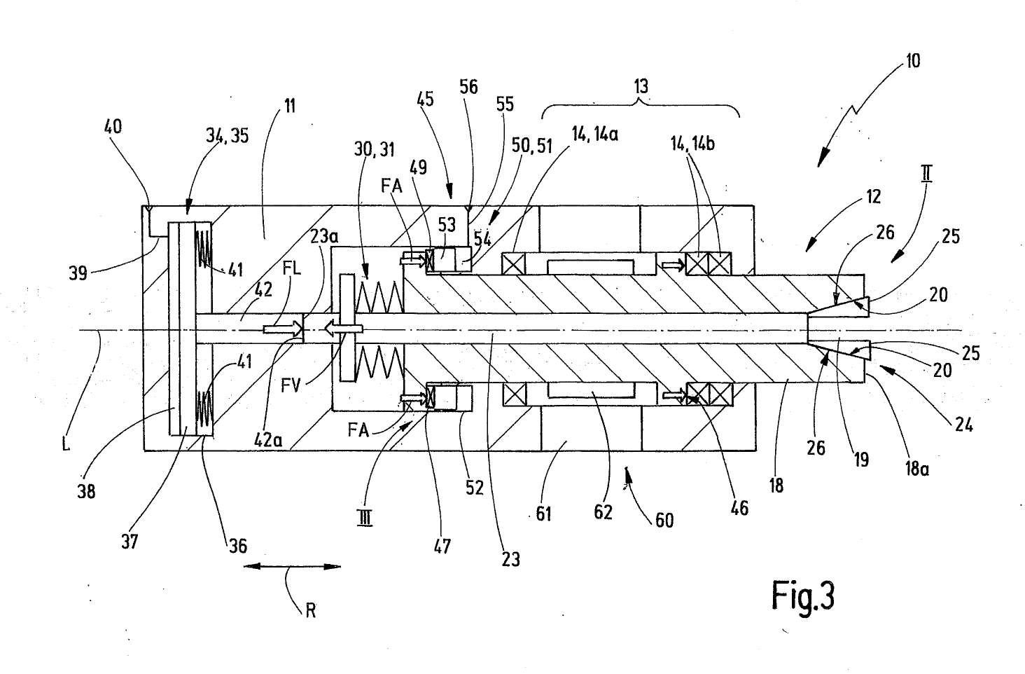

FIG. 3 the axle arrangement according to FIGS. 1 and 2 with a support unit switched into a support state.

FIGS. 1 to 3 illustrate the basic principle of an exemplary embodiment of an axle arrangement 10 in a highly schematized manner. The axle arrangement 10 comprises a base body 11. FIGS. 1 to 3 show the base body 11 simplified in one piece; however, in specific exemplary embodiments, it consists preferably of several components. A receiving unit 12 is arranged in the base body 11. The receiving unit 12 is supported so as to be rotatable about a longitudinal axis L by means of a swivel bearing assembly 13 in the base body 11. The swivel bearing assembly 13 has, viewed in a longitudinal direct R parallel to the longitudinal axis L, at least two bearings 14 that are arranged spaced apart relative to each other. The bearings 14 are preferably configured as anti-friction bearings. In the exemplary embodiment according to FIGS. 1 to 3 described here, the swivel bearing assembly 13 includes at least one rear bearing 14a arranged at a rear bearing location and at least one front bearing 15b arranged in longitudinal direction R at a distance therefrom at a front bearing location. As illustrated, two front bearings 14b are present in accordance with the example. The front bearings 14b are preferably configured as angular ball bearings. The front bearings 14b may thus absorb or support not only radial forces for the swivel bearing of the receiving unit 12 but also axial forces. The rear bearing 14a is preferably configured as a radial bearing and only disposed for absorbing radial forces.

The receiving unit 12 includes a receiving sleeve 18 that is rotatably supported on the base body 11 for the swivel bearing assembly 13. On a front end associated with the tool or workpiece to be received, the receiving sleeve 18 has a receiving opening 19. In the exemplary embodiment, the receiving opening 19 preferable opens conically toward the front end 18a of the receiving sleeve 18. In so doing, contact surfaces 20 are formed within the receiving opening 19, said contact surfaces extending obliquely inclined toward the longitudinal axis L.

Furthermore, the receiving unit 12 comprises a gripper actuating element 23 arranged in the receiving sleeve 18 so as to be slidable along the longitudinal axis L. In the exemplary embodiment, the gripper actuating element 23 has a rod-shaped or bar-shaped configuration and may also be referred to as a pushrod. At the end associated with the receiving opening 19, a gripper unit 24 is connected to the gripper actuating element 23. The gripper unit 24 may comprise several gripper jaws 25 that abut with one counter-contact surface 26, respectively, against a contact surface 20 in the receiving opening 19. Due to the obliquely inclined contact surfaces 20, the gripper jaws 25, when the gripper actuating element 23 is being slid in longitudinal direction R, move—radially with respect to the longitudinal axis L—toward each other or away from each other. FIG. 1 shows, schematically, a clamping position I in which the gripper unit 24 clamps a workpiece or a tool between the gripper jaws 25. FIG. 1 only schematically shows the clamped-in shaft 27 of the workpiece or tool.

FIGS. 2 and 3 show the release position II of the gripper unit 24. In so doing, the gripper unit 24 is slid, together with the gripper actuating element 23, relative to the clamping position I in longitudinal direction R, so that the gripper jaws 25—compared with the clamping position I—are at a greater distance from each other radially with respect to the longitudinal axis L and that a tool or workpiece can be inserted between the gripper jaws 25 or be removed from the region between the gripper jaws 25. In this release position II, the gripper actuating element 23 is slid relative to the clamping position I toward the front end 18a of the receiving sleeve 18.

Furthermore, the receiving unit 12 comprises a pretension unit 30. The pretension unit 30 generates a pretension force FV between the gripper unit 24 and the receiving sleeve 18, said pretension unit being oriented parallel to the longitudinal axis L, i.e., in longitudinal direction R. The pretension force FV acts in such a manner that the gripper actuating element 23 is pushed away or pulled away from the front end 18a, and thus the gripper unit 24 is forced into the receiving opening 19 and, is pulled, for example. By supporting the gripper jaws 25 on the oblique contact surfaces 20, a clamping or pretension force is effected between the gripper jaws 25 and an inserted tool or workpiece.

In the exemplary embodiment, the pretension unit 30 is represented by a spring assembly 31. The spring assembly 31 may contain disk springs and/or helical springs. The position of the pretension unit 30 or the spring assembly 31 within the receiving unit 12 can be selected at a suitable location. In the exemplary embodiment shown here, the spring assembly 31 acts as a pressure spring assembly that generates a pressing force between the receiving sleeve 18 and the gripper actuating element 23.

The axle arrangement 10 includes a release unit 34. The release unit 34 is disposed to apply a release force FL to the gripper actuating element 23 counter the pretension force FV when the gripper unit 24 is to be moved out of the clamping position I into the release position II. The release force FL is schematically shown in FIGS. 2 and 3. The release force FL may be generated electrically and/or hydraulically and/or pneumatically.

In the exemplary embodiment described here, the release unit 34 comprises a first pneumatic cylinder 35. The first pneumatic cylinder 35 has a first cylinder space 36, in which a first piston 37 of the first pneumatic cylinder 35 is arranged so as to be slidable in longitudinal direction R and, in so doing, delimits a first working chamber 38 in a fluid-tight manner in the first cylinder space 36. A first pneumatic line 39 connects the first working chamber 38 to a first pneumatic connection 40. The first pneumatic line 39 may be configured as a channel within the base body 11.

The first pneumatic cylinder 35 is configured as a simply acting cylinder. The first piston 37 is forced by a spring assembly having at least one spring 41 into a home position (FIG. 1). Seated on the first piston 37 is a piston rod 42. The piston rod 42 has a piston rod end 42a that is associated with an inside end 23a of the gripper actuating element 23. If the piston 37 having the piston rod 42 is in the home position shown in FIG. 1, the piston rod end 42a does not abut against the inside end 23a of the gripper actuating element 23.

By applying pressurized air to the first working chamber 38—via the first pneumatic connection 40 and the first pneumatic line 39—the piston 37 with the piston rod 42 is first moved toward the gripper actuating element 23 until the piston rod end 42a and the inside end 23a of the gripper actuating element 23 abut against each other. Subsequently, a release force FL is applied to the gripper actuating element 23 via the piston rod 42, said release force counter-acting the pretension force FV and being greater than the pretension force FV. The result of this is that the gripper actuating element 23 with the gripper unit 24 can be slid—counter the pretension force FV—relative to the receiving sleeve 18 along the longitudinal axis L. As a result of this, the gripper unit 24 can be moved out of the clamping position I (FIG. 1) into the release position II (FIGS. 2 and 3). The stroke performed in this manner by the gripper actuating element 23 and the gripper unit 24 is relatively small and may amount to only a few millimeters.

The receiving sleeve 18 has a first support surface 46. The first support surface 46 is oriented radially with respect to the longitudinal axis L. In the exemplary embodiment, the first support surface 46 is formed as an annular surface on a step or a flange of the receiving sleeve 18. The at least one front bearing 14b of the swivel bearing assembly 13 abuts against the first support surface 46. This at least one front bearing 14b is disposed to also support—in addition to radial forces—small axial forces between the receiving sleeve 12 and the base body 11. In the exemplary embodiment, the at least one front bearing 14b is configured as an angular ball bearing.

Furthermore, a second support surface 47 is provided on the receiving sleeve 18, said support surface being oriented, for example, radially with respect to the longitudinal axis L. The second support surface 47 is formed on a step or flange and encloses the longitudinal axis L—in accordance with the example in an annular and preferably coaxial manner. The first support surface 46 and the second support surface 47 face toward the front end 18a of the receiving sleeve 18.

Furthermore, the axle arrangement 10 comprises a support unit 48 that includes an auxiliary bearing 49 and an activatable actuating unit 50. In the exemplary embodiment, the actuatable actuating unit 50 is a second pneumatic cylinder 51. The second pneumatic cylinder 51 has, formed on a base body 11, a second cylinder space 52 in which a second piston 53 of the second pneumatic cylinder 51 is arranged so as to be slidable in longitudinal direction R. The second piston 52 fluidically delimits a second working chamber 54 in the cylinder space 52. The second working chamber 54 is connected to a second pneumatic connection 56 via a second pneumatic line 55. The second pneumatic line 55 may be configured as a channel in the base body 11.

The auxiliary bearing 49 is arranged between the second support surface 47 and the second piston 53. The working chamber 54 is located on the side of the second piston 53 opposite the auxiliary bearing 49. When pressure is applied to the second working chamber 54, the second piston 53 pushes the auxiliary bearing 49 against the second support surface 47 and, in conjunction with this, generates a pressing force FA (FIG. 3).

In the position shown by FIG. 3, the auxiliary bearing 49 is pressed by the actuating unit 50 with a pressing force FA against the receiving sleeve 18 and, in accordance with the example, against the second support surface 47, in which case the support unit 48 is in a support state III. If the actuating unit 50 of the support unit 48 does not generate a pressing force FA (FIGS. 1 and 2), the support unit 48 is in a rest state IV. In this rest state IV, the auxiliary bearing 49 may essentially abut, without force or loosely, against the second support surface 47 and thus against the receiving sleeve 18. FIGS. 1 and 2 show the rest position IV in that the auxiliary bearing 49 is arranged without contact opposite the receiving sleeve 18; however, this is not absolutely necessary. Important is that a state of non-actuated passiveness, as it were, occurs due to the actuating unit 50 and that no pressing force FA between the auxiliary bearing 49 and the receiving sleeve 18 is generated.

The support unit 49 is disposed to accomplish—in release position II—an additional support of the receiving unit 12 and, in accordance with the example, of the receiving sleeve 18 on the base body 11. To do so, the support unit 48 is switched into the support state III before, during or after moving the gripper unit 23 into the release position II, in which the auxiliary bearing 49 is pressed with the pressing force FA against the receiving sleeve 18. In accordance with the example, the auxiliary bearing 49 is embodied as an axial bearing and supports an axial force acting between the base body 11 and the receiving sleeve 18. Consequently, not the entire axial force that acts due to the release unit 34 in release position II between the receiving unit 12 and the base body 11 is absorbed by the swivel bearing assembly 13 and, in accordance with the example, the at least one front bearing 14b. Rather, the axial force distributes itself to the at least one front bearing 14b and the auxiliary bearing 49. The axial force load of the at least one front bearing 14b decreases as a result of this. This allows the rotation of the receiving unit 12 into the release position II about the longitudinal axis L, without excessive wear and without causing damage to the at least one front bearing 14b.

For driving the receiving unit 12 about the longitudinal axis L, the axle arrangement comprises a drive unit 60. The drive unit 60 may be, for example, an electric motor with a stator 62 in a rotor 62. The stator 61 is arranged on the base body 11, whereas the rotor 62 is non-rotatably connected to the receiving unit 12 and, for example, to the receiving sleeve 18. In the exemplary embodiment shown here, the drive unit 60 represented by the electric motor is arranged, in longitudinal direction R, in the at least one front bearing 14b of the swivel bearing assembly 13.

Furthermore, the axle arrangement 10 may comprise a control unit 63. The control unit 63 is disposed to activate the drive unit 60 and/or the release unit 34 and/or the support unit 48. Consequently, the control unit 63 can initiate or stop the rotation of the receiving unit 12 about the longitudinal axis L, or effect the movement of the gripper unit 24 between the clamping position I and the release position II by means of the release unit 34, or effect the switching of the support unit 48 between the support state III and the rest state IV. To do so, the control unit 63 in the exemplary embodiment can make possible the supply of pressurized air to the respective work chambers 38 and 54, respectively, or vent the respective work chambers 38 and 54, respectively. The control arrangement 63 can control the rotation of the electric motor by means of a motor control unit. The pneumatic and/or electrical and/or electronic means necessary therefor are not illustrated in detail and may be implemented in the manner known per se. For reasons of simplicity, the control unit 63 is shown only in a highly schematic manner in FIG. 1. The number of required output and/or input signals may vary.

For inserting or removing a tool or a workpiece, the procedure is as follows:

The gripper unit 24 is moved into its release position II by means of the release unit 34. In this state, a tool or workpiece can be removed or inserted. At the same time, immediately beforehand or immediately thereafter, the support unit 48 is switched into the support state III in which the auxiliary bearing 49 provides an axial force support between the receiving unit 12 and, as in the example, the support sleeve 18 on the one hand and the base body on the other hand. The auxiliary bearing 49 thus supports a part of the axial force that acts due to the release unit 34 between the receiving unit 12 and the base body 11 (FIG. 3). Consequently, it is possible to drive the receiving unit 12 in the release position II of the gripper unit in a rotating manner about the longitudinal axis L, should this be necessary or advantageous for the insertion or for the removal of a tool or workpiece. The total load applied to the swivel bearing assembly prevailing due to the rotation and the axial force in the release position II is sufficiently small due to the auxiliary bearing.

Subsequently, the release unit 34 is again deactivated so that it no longer generates a release force FL. In the exemplary embodiment, this takes place in that the working chamber 38 is vented toward the environment. Due to the pretension force FW of the pretension unit 30, the gripper actuating element 23 is moved inward away from the front end 18a of the receiving sleeve 18, as a result of which the gripper unit 24 returns into its clamping position I and clamps a workpiece or a tool in place. Before, during or after this, the support unit 48 may be switched into its rest state IV (FIG. 1). The swivel bearing assembly 13 need not absorb any or only minimal axial forces, so that the auxiliary bearing 49 is not necessary and, therefore, it is not necessary to exert pressure with a force against the receiving sleeve 18 via the support unit 48.

The invention relates to an axle arrangement 10 for mounting a tool or a workpiece. The axle arrangement 10 comprises a receiving unit 12 that is supported by a swivel bearing assembly 13 in a base body 11 so as to be rotatable about a longitudinal axis L. The receiving unit 12 has a receiving sleeve 18 that is supported so as to be immovable in longitudinal direction R parallel to the longitudinal axis L and has a gripper actuating element 23 that is supported so as to be slidable in the receiving sleeve 18 along the longitudinal axis L. On one end of the gripper actuating element 23 associated with the front end 18a of the receiving sleeve 18, there is seated a gripper unit 24 for gripping the tool or the workpiece. The gripper unit 24 is pretensioned by a pretension unit 30 in a clamping position I. An actuatable release unit 34 can move the gripper unit—counter the pretension force FV of the pretension unit 30—into a release position II. By means of a support unit 48, an auxiliary bearing 49 that, in particular, is configured as an axial bearing, can be pressed against the receiving sleeve 18 in order to achieve an improved axial force support of the receiving unit 12 on the base body 11 and to reduce the load on the swivel bearing assembly 13 due to axial forces.

### LIST OF REFERENCE SIGNS

10 Axle arrangement

11 Base body

12 Receiving unit

13 Swivel bearing assembly

14 Bearing of the swivel bearing assembly

14a Rear bearing

14b Front bearing

18 Receiving sleeve

18a Front end of the receiving sleeve

19 Receiving opening

20 Contact surface

23 Gripper actuating element

23a Inside end of the gripper actuating element

24 Gripper unit

25 Gripper jaw

36 Counter-bearing surface

30 Pretension unit

31 Spring assembly

34 Release unit

35 First pneumatic cylinder

36 First pneumatic cylinder space

37 First piston

38 First working chamber

39 First pneumatic line

40 First pneumatic connection

41 Spring

42 Piston rod

42a Piston rod end

46 First support surface

47 Second support surface

48 Support unit

49 Auxiliary bearing

50 Actuating unit

51 Second pneumatic cylinder

52 Cylinder space

53 Second piston

54 Second working chamber

55 Second pneumatic line

56 Second pneumatic connection

60 Drive unit

61 Stator

62 Rotor

63 Control unit

I Clamping position

II Release position

III Support state

IV Rest state

FA Pressing force

FL Release force

FV Pretension force

L Longitudinal axis

R Longitudinal direction

1-15. (canceled)

16. Axle arrangement for mounting a tool or a workpiece comprising:
a base body;
a receiving unit supported by means of a swivel bearing assembly on the base body so as to be rotatable about a longitudinal axis (L), the receiving unit including a receiving sleeve with a receiving opening;
a gripper actuating element that can be slid in the receiving sleeve along the longitudinal axis (L), the gripper actuating element having on one end, a gripper unit for the tool or the workpiece, said gripper unit being arranged at least in part in the receiving opening;
a pretension unit that is disposed to generate a pretension force acting in longitudinal direction parallel to the longitudinal axis (L) between the gripper unit and the receiving unit in order to force the gripper unit into a clamping position;
an actuatable release unit that is disposed to slide the gripper actuating element with the gripper unit counter the pretension force of the pretension unit relative to the receiving sleeve in order to move the gripper unit out of the clamping position into a release position; and
a support unit that is arranged on the base body and that includes an auxiliary bearing and an actuating unit for switching the support unit between a support state and a rest state, wherein the actuating unit is disposed to generate a pressing force in the support state and press the auxiliary bearing against the receiving sleeve.

17. Axle arrangement according to claim 16, wherein in the rest state of the support unit, the actuating unit is without any force-imparting effect on the auxiliary bearing.

18. Axle arrangement according to claim 16, wherein the auxiliary bearing is an axial bearing.

19. Axle arrangement according to claim 16, wherein the swivel bearing assembly comprises at least one radial bearing.

20. Axle arrangement according to claim 16, wherein the swivel bearing assembly comprises at least one combined radial/axial bearing.

21. Axle arrangement according to claim 16, wherein the receiving sleeve has a first support surface oriented radially with respect to the longitudinal axis (L).

22. Axle arrangement according to claim 21, wherein the swivel bearing assembly comprises at least one combined radial/axial bearing that abuts against the first support surface.

23. Axle arrangement according to claim 21, wherein the receiving sleeve has a second support surface oriented radially with respect to the longitudinal axis (L).

24. Axle arrangement according to claim 23, wherein the actuating unit is disposed to press the auxiliary bearing in the support state against the second support surface.

25. Axle arrangement according to claim 16, wherein the actuating unit comprises an actuating cylinder.

26. Axle arrangement according to claim 25, wherein a piston of the actuating cylinder is configured as an annular piston that is arranged coaxially with respect to the longitudinal axis (L).

27. Axle arrangement according to claim 16, further comprising a control unit disposed for activating the actuating unit and the release unit.

28. Axle arrangement according to claim 27, wherein the control unit is disposed to switch the support unit into the support state, immediately before, during or immediately after the gripper unit is moved or was moved into the release position.

29. Axle arrangement according to claim 27, further comprising a drive unit that can be activated by means of the control unit for driving the receiving unit about the longitudinal axis (L).

30. Method for operating an axle arrangement according to claim 16, comprising:
switching the support unit into the support state;
moving the gripper unit into the release position;
removing and/or inserting a tool or workpiece in the gripper unit;
moving the gripper unit into the clamping position; and
switching the support unit into the rest state.
